(19) United States
(12) Patent Application Publication
(10) Pub. No.: US 2006/0198363 A1
(43) Pub. Date: Sep. 7, 2006

(54) Apparatus and method for computer telephony integration

(75) Inventors: Jonathan Silverman, Minneapolis, MN (US); Alvin Wong, Maple Grove, MN (US); Ashref Mohamed, Blaine, MN (US); Andrew Bauer, East Bethel, MN (US)

Correspondence Address: ALTERA LAW GROUP, LLC, 6500 CITY WEST PARKWAY, SUITE 100, MINNEAPOLIS, MN, 55344-7704, US

(73) Assignee: Spanlink Communications, Minneapolis, MN (US)

(21) Appl. No.: 11/339,403

(22) Filed: Jan. 25, 2006

Related U.S. Application Data
(60) Provisional application No. 60/659,758, filed on Mar. 7, 2005.

(51) Int. Cl. H04L 12/66

(52) U.S. Cl. 370/352

(57) ABSTRACT

An agent at a contact center uses a soft phone embedded in the agent's desktop to converse with a customer, to set the agent's Automatic Call Distribution (“ACD”) state, and to control the phone's call control state. Computer Telephony Integration (“CTI”) technology is used in many ways at the contact center, including for accessing CTI data and executing CTI methods. CTI data can include information about the calling number, called number, caller entered digits, and the queue the call came from. CTI methods can include call control operations such as answering a call, making a call, and transferring a call. In addition, CTI methods can also include ACD specific operations, such as setting an agent's state and querying the state of a queue of customers. A web browser is also embedded in the agent's desktop, and one or more web-based applications are integrated into the web browser. These applications may be web-based enterprise applications or other web-based applications such as available over the internet. A new type of workflow action called an Hypertext Transfer Protocol Action or “HTTP Action” is used for integrating the CTI data with the web browser.

### CROSS-REFERENCE TO RELATED APPLICATIONS

This application claims the benefit of U.S. Provisional Application No. 60/659,758 filed Mar. 7, 2005, which hereby is incorporated herein by reference in its entirety.

### BACKGROUND OF THE INVENTION

1. Field of the Invention

The present invention relates to computer telephony, and in particular to integrating telephony data with computer applications.

2. Description of Related Art

Contact center products use Computer Telephony Integration (“CTI”) technology in many ways. CTI technology provides programmatic methods for accessing CTI data and executing CTI methods. CTI data can include information about the calling number, called number, caller entered digits, and the queue the call came from. CTI methods can include call control operations such as answering a call, making a call, and transferring a call. In addition, CTI methods can include Automatic Call Distribution (“ACD”) specific operations. For example, ACD specific operations can include setting an agent's state and querying the state of a queue of customers.

A classic use of CTI technology is for populating data into a software application running on an agent's desktop. This is called a screen pop. A screen pop is typically executed when an agent begins a voice conversation with a customer. The goal of the screen pop is to increase the agent's productivity and the customer's satisfaction by reducing the amount of time to service the customer and automating the display of information about the caller.

FIG. 1 shows an illustrative agent desktop 120 in which CTI data 110, which is obtained from a CTI Server 108, can be integrated into two applications. The first application is a software-based telephone, called a soft phone 160, that is used by the agent for setting their ACD state and controlling a phone's call control state. A typical ACD state operation is transitioning from a “Not Ready” state to a “Ready” state. Typical call control state operations include answering, transferring, and putting on hold a call. An agent pushing a button on the soft phone accomplishes the operations. The soft phone integrates a CTI Application Programming Interface (“API”) 150 in order to accomplish its work. The screen pop occurs within the soft phone by displaying the data to the agent.

The second application in which CTI data 110 can be integrated is an enterprise's business application 140. The enterprise application has information about the customer or the topic that the customer is calling to discuss. The enterprise business application may have: 1) been developed prior to the desire to integrate CTI data with it (such as a preexisting application); 2) been developed from a third party software vendor or by the customer's IT staff; and/or 3) been a shrink-wrap or a custom application.

One example of how data can be integrated with the enterprise business application is by using the “calling number” or Automatic Number Identification (“ANI”) to index into a database of customer records, and display information about the customer to the agent prior to the beginning of the conversation. Another example involves using data collected from an IVR is to collect a trouble ticket number from the caller, index into a help desk system and display information to the agent about the caller's trouble ticket prior to the beginning of the conversation.

There are three general approaches for integrating CTI data with enterprise applications. The first two approaches are to use: 1) a standard programming language such as visual BASIC, C++ or Java with a CTI API; or 2) a proprietary scripting language that has procedural extensions for accessing the CTI data. The third approach involves a non-procedural specification of what telephony data is to be integrated with which desktop application. These are represented in FIG. 1 by API/Script/Rules program 130.

The first approach extends standard programming language by defining a new application programming interface for that standard programming language. The API defines a set of methods by which a programmer can gain access to the CTI data. It requires knowledge of a given procedural programming language and learning about a CTI API. An Information Technology (“IT”) department must have access to the source code of its enterprise application, or have a third party software vendor do the CTI integration. The application source code is modified to call the relevant API functions in the appropriate place in the program's logic.

The second approach is for a CTI vendor to define a self-contained proprietary scripting language. The scripting language provides a programming environment for a customer to develop enterprise applications. It provides a procedural language for writing programming logic. The language constructs provide access to CTI data. The scripting language is a self-contained environment in which the desktop application is executed. As such the scripting language approach is a closed environment that is explicitly limited by the script functions provided by the vendor (or creator). For example, access to host data in a script can only be done if the vendor provides methods such as terminal emulation and database access. Integration of CTI and/or host data into a desktop application will require the script vendor to provide additional scripting methods and for the enterprise's IT staff to modify their desktop applications.

These first two approaches suffer from their dependence on programming skills. These approaches require that an installer or user have programming skills to set up and operate the CTI. The approaches also can be time consuming when a programmer needs to develop a specific program for integration. Thus, a need exists for systems that allows a user or installer to integrate and expand the use of telephony data without requiring programmer skills, and to extend the CTI functioning without requiring a heavy investment of time by a non-programmer.

The third approach, unlike the above two approaches, is user-friendly, and does not require that an installer (or user) have programming skills to set up and operate the CTI. The third approach provides a method for declaring in a non-procedural manner what telephony data is to be integrated with which enterprise application. It assumes that an enterprise's host and desktop applications exist and that there be no modifications made to their source code.

This third approach is used in the work of Walsh et al., “Call processor for a computer telephone integration system” in U.S. Pat. No. 5,642,410; Walsh et al., “Switching device independent computer-telephone integration system”, U.S. Pat. No. 5,655,014 and Walsh et al., “Computer telephone integration system”, U.S. Pat. No. 5,655,015.

### BRIEF SUMMARY OF THE INVENTION

Although the Walsh implementation of the third approach enjoys the advantages of using a non-procedural specification for computer telephony integration, it does not effectively integrate CTI data with existing Web-based enterprise applications in a non-procedural manner. A need therefore exists for the effective integration of CTI data with Web-based enterprise applications.

Advantageously, the present invention effectively integrates CTI data with Web-based enterprise applications, and more generally, with any Web-based application. This may be accomplished through, for example, a workflow automation model and integration of telephony data with a Web browser. Advantageously, the present invention in some embodiments extends integration to include Interactive Voice Response (“IVR”) collected information in addition to traditional telephony data. Advantageously, the web browser may be imbedded in an agent desktop, so that no modification to the source code of the Web application is required.

Advantageously, a user of the invention does not need programming skills to set up and operate. A system administrator can provide a non-procedural specification of what telephony data is to be integrated with a Web-based application. The end user can develop the client application using standard browser capabilities. And host applications are similarly developed using technologies that the user desires.

One embodiment is a method of computer telephony integration that establishes an agent desktop; embeds a web-based browser in the agent desktop; integrates a web-based application with the browser; and establishes a workflow automation model having a plurality of events, a plurality of respective rules for the events, and a plurality of respective actions for the rules, wherein each of the rules is expressed as one or more relations on computer telephony integration (“CTI”) data, and wherein at least one of the actions is an HTTP action having a request data field. In this method, the occurrence of one of the events in the workflow automation model causes an evaluation of a respective one of the rules. Then, upon valid evaluation of the evaluated rule executes the HTTP action with the browser to obtain requested data in accordance with the request data field; and provides the requested data to the web-based application.

Another embodiment is a contact center system having a broadband internet connection; a computer telephony integration (“CTI”) server; and a client computer coupled to the internet connection and having associated therewith computer instructions for: establishing an agent desktop on the client computer; embedding a web-based browser in the agent desktop; integrating a web-based application with the browser; and establishing a workflow automation model comprising a plurality of events, a plurality of respective rules for the events, and a plurality of respective actions for the rules, wherein each of the rules is expressed as one or more relations on computer telephony integration (“CTI”) data, and wherein at least one of the actions is an HTTP action having a request data field. Then, the system upon occurrence of one of the events in the workflow automation model, populates a respective one of the rules with CTI data from the CTI server, and evaluates the populated rule. Upon valid evaluation of the evaluated rule, the system executes the HTTP action with the browser to obtain requested data via the internet connection in accordance with the request data field; and provides the requested data to the web-based application integrated in the browser.

Yet, another embodiment is a computer readable medium having computer program instructions stored thereon, having: instructions for establishing an agent desktop; instructions for embedding a web-based browser in the agent desktop; instructions for integrating a web-based application with the browser; and instructions for establishing a workflow automation model comprising a plurality of events, a plurality of respective rules for the events, and a plurality of respective actions for the rules, wherein each of the rules is expressed as one or more relations on computer telephony integration (“CTI”) data, and wherein at least one of the actions is an HTTP action having a request data field. The computer program instructions further having instructions for, upon occurrence of one of the events in the workflow automation model, evaluating a respective one of the rules; instructions for, upon valid evaluation of the evaluated rule, executing the HTTP action with the browser to obtain requested data in accordance with the request data field; and instructions for providing the requested data to the web-based application.

### BRIEF DESCRIPTION OF THE SEVERAL VIEWS OF THE DRAWINGS

FIG. 1 is a schematic drawing of an agent desktop as in the prior art.

FIG. 2 is a schematic drawing of a novel agent desktop.

FIG. 3 is a view of a screen for a workflow rule specification.

FIG. 4 is a view of a screen for a specification of a relation for a data condition.

FIG. 5 is a view of a screen for a specification of Computer Telephony Integration (“CTI”) data for the specified relation.

FIG. 6 is a view of a screen for a specification of an action.

FIG. 7 is a view of a screen showing a web application executing within an agent window container application.

FIG. 8 is a view of a screen for selecting a web application integration action.

FIG. 9 is a view of a screen specifying the web page for CTI integration.

FIG. 10 is a view of a screen specifying the telephony data to be integrated with the web based computer application.

FIG. 11 is a view of a screen showing an HTTP Action setup.

FIG. 12 is a view of a generalized state machine having several states.

FIG. 13 is a table that shows an abstracted view of the internal operation of the desktop with an illustrative set of workflows.

FIG. 14 is a view of a state machine having various events, including a ringing event.

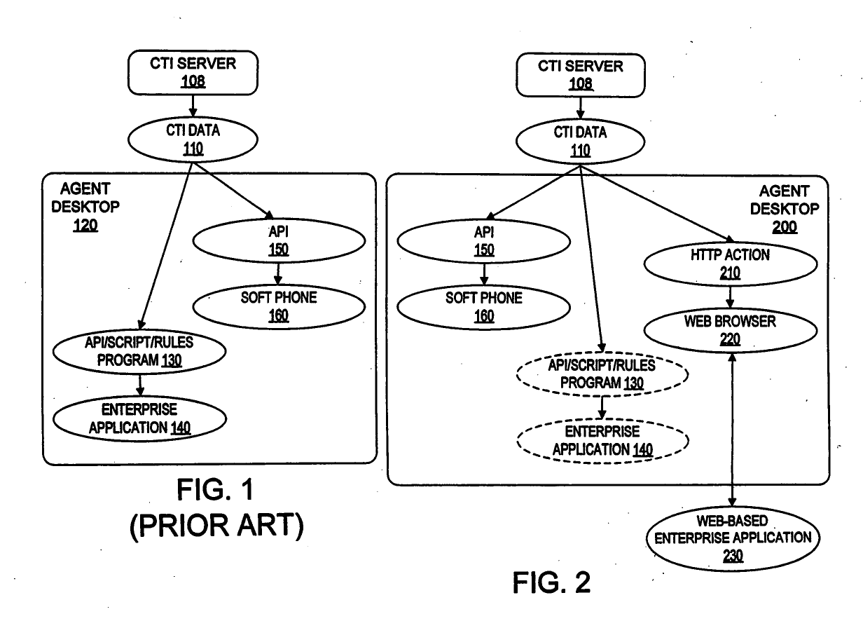

### DETAILED DESCRIPTION OF THE INVENTION

The computer telephony integration approach described herein, which uses a workflow automation model, allows a user such as, for example, a system administrator, to provide a non-procedural specification for the integration of CTI data with existing enterprise applications as well as web-based applications, whether or not enterprise applications. The user is not required to have programming skills, and even a non-programmer may set up and operate the system in a few hours in comparison to days that would be required to develop a similar program. The techniques described herein may be implemented on commercially available personal computers, workstations, and servers as appropriate, or on customized special purpose computing equipment.

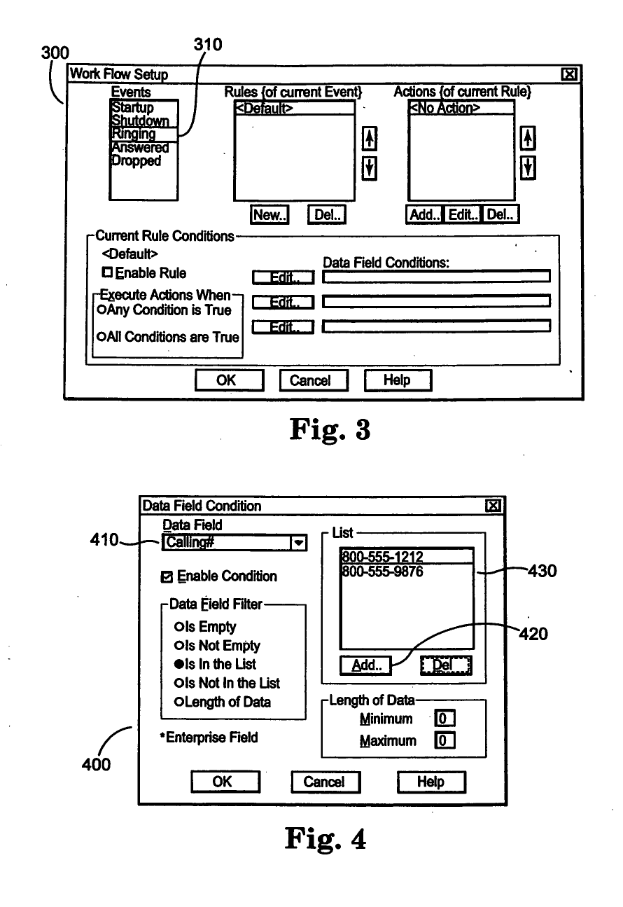

FIG. 2 shows an illustrative agent desktop 200. As in known systems, the CTI data 110 may be integrated into the soft phone 160 using the API 150, and may continue to be integrated into enterprise applications such as the application 140 using an API, script, or rules program 130. However, the agent desktop 200 also contains an embedded web browser 220 for integrating one or more web-based applications 230, which includes web-based enterprise applications but which may include other applications as well. A new type of workflow action called an Hypertext Transfer Protocol Action or “HTTP Action” 210 is used for integrating the CTI data 110 with the web browser 220.

Desktop Workflow Automation Model

Common goals of a desktop workflow automation, whether web-based applications or not, are often to: 1) integrate customer contacts (more generally, telephony information) with an enterprise's software applications without the modification of the application's source code; 2) provide a method for customers to configure the operation of a product to match their business needs; 3) allow workflow rules to be specified by a contact center's operations staff without the use of IT staff; and 4) automate mundane and complex tasks for contact center employees.

The implementation of workflow automation meets these goals. It excels in automating a contact center's agents interactions with customers on voice calls through the use of a simple, yet powerful workflow model. A workflow is modeled as a specification setting forth a set of events, rule(s) and action(s). An event is an occurrence of a contact center activity that corresponds to a real world state transition such as a phone ringing at an agent position, an agent ACD state transition or time of day. For each event there are sets of rules that are evaluated in order to determine what actions to perform. A set of actions is defined for each set of rules. The action set defines the integration of the telephony data with a desktop application and the execution of the desktop application.

For example, FIG. 3 is a view of a Work Flow Setup screen 300 that shows a workflow rule specification used to define workflows. A user specifies the event such as “Ringing” (list item 310) that causes a workflow to be evaluated. Events for a voice contact may include an agent's telephone ringing, a call being answered, a call being ended, or an ACD agent state change.

When an event occurs, a rule is evaluated to determine if the workflow should be executed. A rule may be expressed as a set of data conditions. A data condition is a relation on CTI data. FIG. 4 is a view of an instance 400 of a Data Field Condition screen that shows the specification of a data condition as a relationship. Illustratively the condition for the Data Field Calling# (field 410) is that it “is in the List” (button 420, list 430). The CTI data available for the data condition includes telephony, ACD and IVR data. IVR data may include user provided data as well as data obtained by the IVR from a host application. FIG. 5 is a view of another instance 500 of the Data Field Condition screen that shows the specification of CTI data (field 410) from a pull down list 510 for the specified relation. The workflow rule may specify that either all of the data conditions must be true or any one of them must be true in order for the workflow to be executed.

When a workflow is determined to be valid, a set of actions is executed. The actions may specify the integration of CTI data with an enterprise's application, execution of a CTI method, or the execution of a contact center operation. An action is an occurrence that happens when a rule is met.

Integration With Web Technologies

Web based computer applications are increasingly becoming an important segment of contact center operations. Advantageously, CTI data including IVR data are integrated with web-based applications using a web-based browser. The web-based browser may be embedded in an agent desktop using any suitable approach. One suitable approach is to use a Windows 32 (“Win 32”) application for workflow interpretation and execution, and embeds a custom web-based browser in the agent desktop.

Another suitable approach is to use a commercial web browser that embeds the agent desktop functionalty. Suitable commercial browsers include Microsoft® Internet Explorer which is available from Microsoft Corporation of Redmond, Wash., and Firefox Web Browser which is available from Mozilla Foundation of Mountain View, Calif. In this approach, the application which executes the workflow is a combination of a server side application and a client side commercial browser. The client side browser application executes in the commercial browser, and follows a web application design instead of the Windows 32 approach.

The technology of the commercial browser approach uses two frames within the commercial browser. The first frame (or top frame) hosts an applet implementing the agent application; the second frame (or bottom frame) hosts a customer's browser application. Alternatively, the features may be implemented or windows instead of frames. The applet implementing the top frame uses the bottom frame as the embedded browser for: end user pages, http post/get results, and supervisor URL pushes. (The same functionality exists in the browser embedded in the Windows 32 agent desktop.) Preferably, all browser controls of the commercial browser are disabled so that users (or agents) cannot inadvertently exit the applet or browse to non-administered web sites. Preferably, the disablement of the browser controls includes removal of the browser toolbars and the address bar, and disabling of the browser right click menu. Preferably, the basic browser controls are supplied by the applet running in the top frame including forward, back, refresh, and stop controls.

In both approaches, the following features illustratively behave the same for a custom web browser as well as commercial web browser.

Specification of Workflows

In this section, our attention turns to the specification of workflows for integrating CTI data including IVR data with web based applications. A web browser embedded in the agent desktop, as described above, offers advantages. For example, advantageously, no modification to a browser based application, no custom programming and no proprietary script based programming are required. The end user may develop the client application using standard browser capabilities. The host application may be developed using the technologies that the user desires.

Embedding a web browser in the agent desktop implements the concept of an agent desktop that includes a container and hosts customer applications. This reduces the number of windows that must reside on the agent's desktop and optimizes the use of screen real estate. It also presents opportunities for easy integration with desktop applications and for the telephony application to easily use the web based application's data. For example, the telephone numbers included in the web page may be automatically converted into hyperlinks as the page is displayed to the agent. This agent may click the link to dial a customer. Similarly it will be possible to do transfers and conferences from telephone numbers in the web pages.

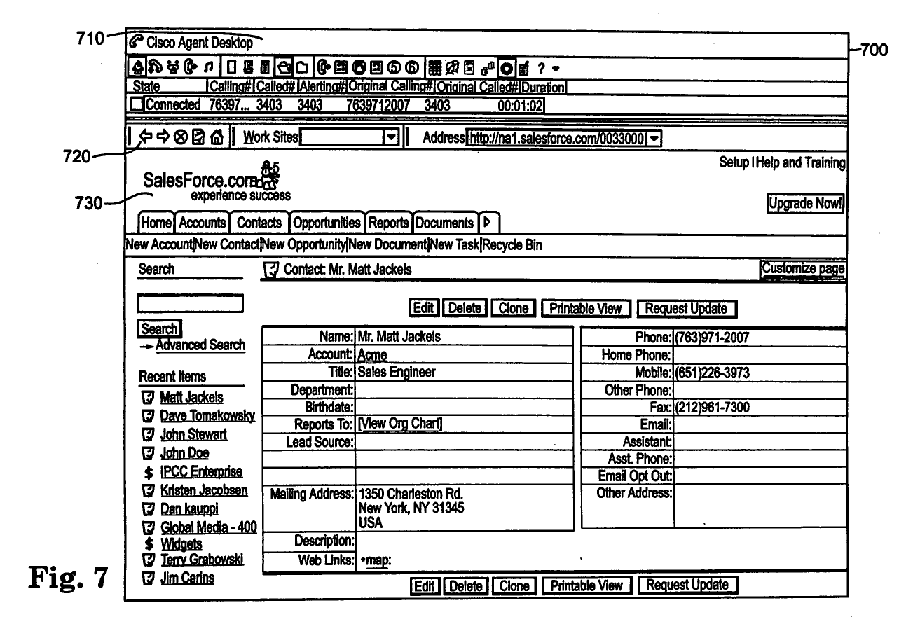

FIG. 7 is a view 700 of a web based customer relationship management application Salesforce.com® (730) executing in a browser 720 that is integrated into an agent desktop 710.

The application integration opportunity for the workflows is described in the following section.

HTTP Post & Get Workflow Actions

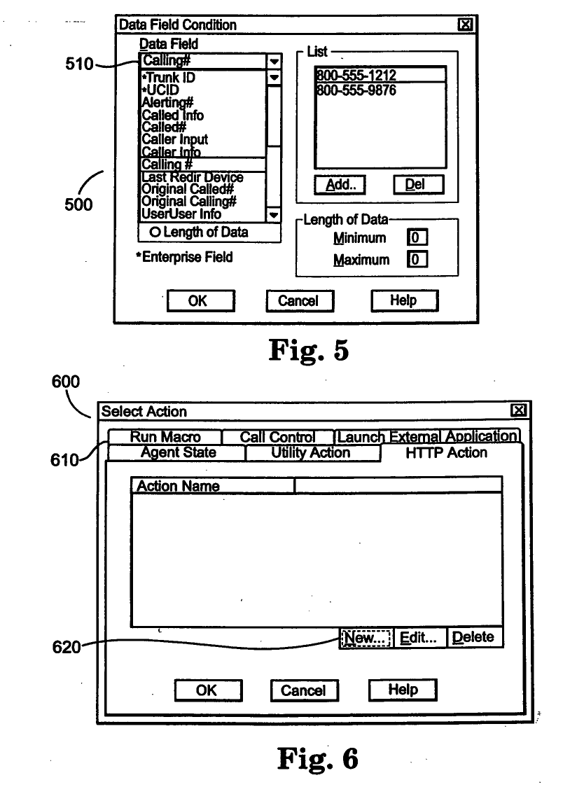

The desktop workflow automation is extended to support the rapid and easy integration of telephony data with web based computer applications. The integration with the embedded browser uses the specification of the event and rule as described previously. FIG. 6 is a view of an instance 600 of a Select Action screen containing an area 610 for listing workflow actions, and from which an existing workflow action may be selected for editing or deletion. New workflow actions may be specified by selecting the New button 620. The specification of a keystroke macro action that integrates CTI data with a standard Windows application may be done in a different screen.

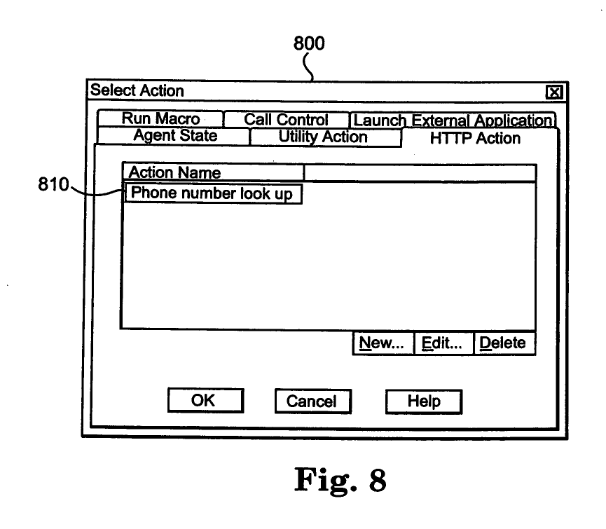

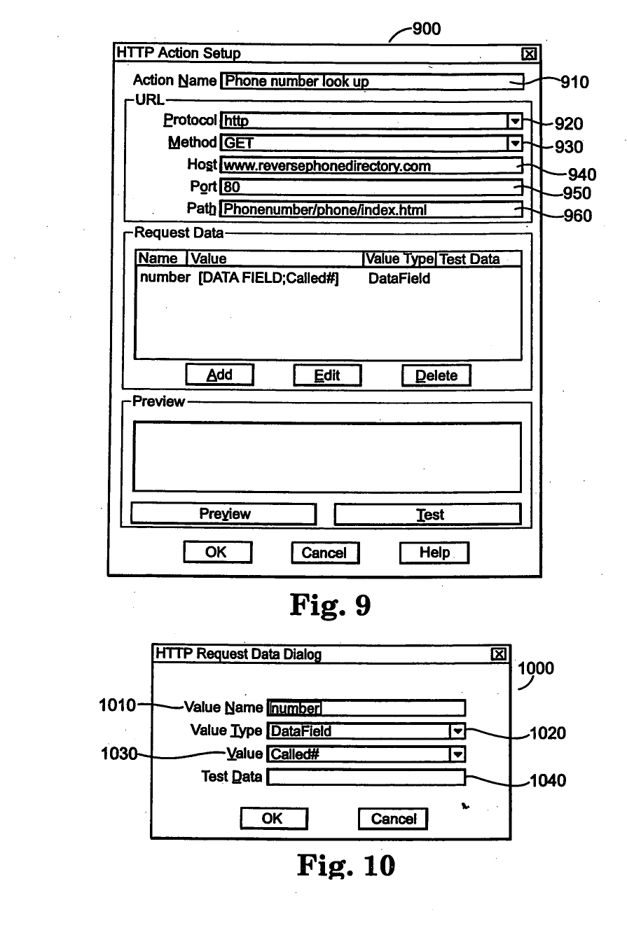

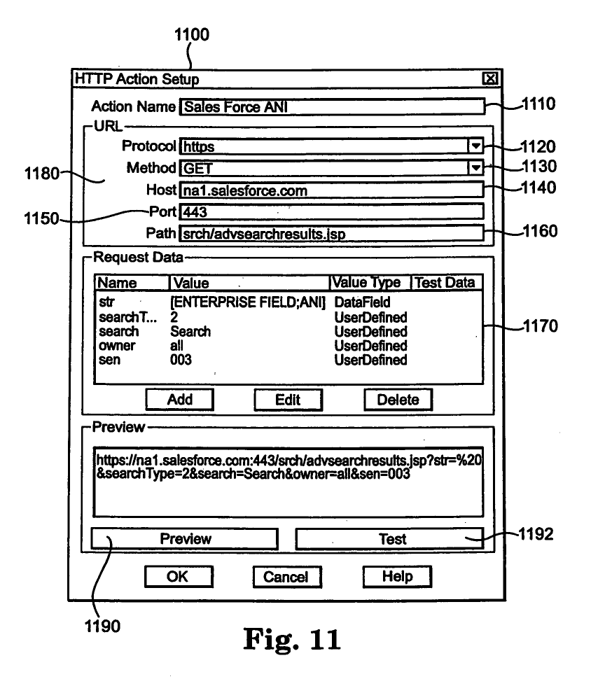

A new type of action is now described for integrating with the browser. The new type of action is called an Hypertext Transfer Protocol Action or “HTTP Action”. The specification of an HTTP action only requires the user to have a limited knowledge of the web page that provides access to the enterprise application. Pointing the browser to the desired page, filling in any form data on that page and executing the page may be used to obtain this information. For an HTTP get action the required information appears in the Universal Resource Locator (“URL”). For an HTTP post operation, the person who implemented the web page may need to be consulted. FIG. 8 is a view of another instance 800 of the Select Action screen that shows the selection of an HTTP action name, specifically “Phone number look up” (item 810). FIGS. 9 and 10 are views of an HTTP Action Setup screen 900 and an HTTP Request Data Dialog screen 1000 that show the specification of the information required for the action.

The request data fields that are specified in the HTTP action provide for the integration of telephony data with the computer application. The request data fields correspond to values entered into a form that are to be passed to a script invoked by the web server. The request data may be telephony data or user-defined data. Telephony data may include traditional CTI data, IVR collected data, and host data from IVR scripts (i.e., database DIPS or 3270/5250 terminal emulation). The user defined data may be strings that the web page requires such as language encoding. FIG. 9 is a view of a screen that shows a request data field that integrated telephony data with a web application.

The HTTP action and request data field are parts of the workflow automation that provide a method for integrating telephony data without requiring a programmer to integrate it. The HTTP action improves on keystroke macros' action in several ways. The keystroke macro method requires multiple keystrokes to navigate to the web page of interest and possibly more keystrokes to navigate to the input control for the data. Using keystroke macros with a web application is similar to a terminal emulation application with regard to screen navigation on a host computer. The HTTP action, however, requires no screen navigation.

Another exceptional advantage of the HTTP action over keystroke macros for web application integration is the absence of the need to manage the timing of the integration of the telephony data with the host application. Browser based applications may have varying response times based on the load on the web server application. The keystroke macros provide a flexible mechanism for managing the timing by allowing the system administrator to control the speed at which the keystrokes are executed, and allows delays to be placed in the keystroke stream as needed. However, this is additional work that needs to be done, and this timing may vary based on the load on the web server. In contrast, there is no need to manage the synchrony of execution between the web server application and the browser when using as HTTP action.

FIGS. 8-10 show an example of a user defining web application integration action using an HTTP Action. First as seen in FIG. 8, the user establishes “phone number look up” (item 810) as the action name for the HTTP Action. As shown in FIG. 9, the user continues by entering data into the HTTP Action setup screen 900 wherein for the action name “Phone number look up” (field 910), the protocol is selected from a pull-down list (not shown) as HTTP (field 920), the method is selected from a pull-down list (not shown) as GET (field 930), the host application is identified by entering www.reversephonedirectory.com (field 940), the port is identified by entering 80 (field 950), and the path is identified by entering phonenumber/phone/index.html (field 960). As shown in FIG. 10, an HTTP Request Data Dialog screen 1000 is used to specify the telephony data to be integrated with the web based computer application. In this instance, the user selected the value name as “number” (field 1010) Value type as a “data field” (field 1020), and Value as the telephony data “called number” (field 1030). The workflow interpretation will use the API (see API 150 in FIG. 2) to provide the CTI Data (see CTI Data 110 in FIG. 2) at runtime.

Before deploying a workflow of the invention in an operational contact center, a user should verify the correct operation of a workflow. There are multiple ways to do the verification. Approaches range from requiring a customer to have a full laboratory system, as one approach, to using simulation tools and tools, as another approach. In the simulation tools and tools approach, the tools are integrated into the system administration tool used to define workflows. The simulation tool approach advantageously allows for immediate verification of the correctness of the workflow using valid data while operating against the actual host application.

FIG. 11 is a view of a completed HTTP Action Setup screen 1100 that shows how a system administration tools enables a system administrator to verify workflows. A button 1190 is provided that allows a system administrator to preview the URL that they have defined in area 1180. This URL can be compared to the URL composed by a commercial browser, such as Microsoft Internet Explorer, when it is accessing the same function of the web application. FIG. 11 also shows a button 1192 for testing the workflow with the web application interface. As shown in FIG. 10, a field 1040 is provided so that test data may be specified for each piece of data that is to be part of the URL. For example, the test data may contain a valid customer telephone number or account number. Executing the test button sends the information to the host via the browser and show the results of the operation.

Using the HTTP Action Setup screen 1100 shown in FIG. 11 as an example, we see how the setup works for a test. The URL to be defined for the action name “Sales Force ANI” (field 1110) is as follows: protocol is—HTTPS (field 1120); method is—GET (field 1130), host application is—na1.salesforce.com (field 1140); port is—443 (field 1150); and path is srch/advsearchresults.jsp (field 1160). As previously described with respect to FIG. 10, a specification is made of the telephony data to be integrated with the web based computer application, and the specification appears in area 1170. In this instance, the first value name is “str” the value is [enterprise field: ANI]; and the value type is DataField. The second value name is “searchType” the value is 2; and the value type is User Defined. The third value name is “search” the value is “Search”; and the value type is User Defined. The fourth value name is “owner” the value is “all” and the value type is User Defined. The fifth or last value name is “sen” the value is “003”; and the value type is User Defined.

In the example using FIG. 11, the HTTP Action method is a GET, and the URL is shown in the preview mode as: https://na1.salesforce.com:443/srch/advsearchresults.jsp?str=%20&searchType=2&search=Search&Owner=all&sen=0 03. This URL may be compared to the URL composed by a commercial browser, such as Microsoft Internet Explorer, when it is accessing the same function of the web application.

Desktop Execution of Workflow

The agent desktop has two main functions. One function of the agent desktop is to provide a set of Graphical User Interface (“GUI”) controls that enable the agent to perform standard ACD functions. The other function of the agent desktop application is execution of the workflows and enablement of portions of the GUI controls. The desktop may use a state machine model to interpret a workflow's events and rules in order to determine when to execute the associated actions. Similarly, a state machine may be used to determine which GUI controls should be enabled.

The agent desktop state machine is based on a set of events, rules and actions. The events model changes in the real world based on the state of a customer contact or an agent. There is a finite set of events. For example, for a telephony contact, the events describe the state of a phone device and may include ringing, answered, and dropped. When an event occurs, a set of rules is evaluated to determine if any are valid.

For example, a rule can be that the telephone number dialed by a customer is one stated in a list. A user defines the set of rules that are of interest for an event. If a rule evaluates in a certain way, such as “true,” a set of user defined actions are executed. The integration of a web page with telephony data described in this document is an action. An action may be to execute a telephony or agent state operation (i.e., change the agent's ACD state), and that action may result in a new event occurring. A user defines the set of actions that are of interest when a rule evaluates true for a given event.

A workflow system may be defined as follows.
1) There is a set of system defined events E={e₁, e₂, . . . , eₙ}.
2) There is a set of user defined rules R={r₁, r₂, . . . rₘ} where a rule is a compound conditional expression where either all of the conditional expressions are true or one of them is true. A conditional expression consists of a binary operator and two operands or a unary operator and one operand. The set of operators and types of operands are defined by the system. A user defines a rule based on their application's business requirements. For example, a rule that a called number should be in a list uses the set operator “member of” with the operand constant “Called Number” and a user defined set of telephone numbers.
3) There is a set of user defined actions A={a₁, a₂, . . . , aₗ} where each action is a system defined function that has a set of user defined operands. The system defined functions that are of interest to this invention are the get/post commands for http/https communication protocol. The user defined operands include the web site URL, page and page specific parameters. If a page specific parameter has a dynamic value, it is automatically provided by the workflow interpreter.
4) A user defined workflow is defined as

$$w = e {\to }^{r} {A}_{k} ,$$

where eεE, rεR and Aₖ⊂A.

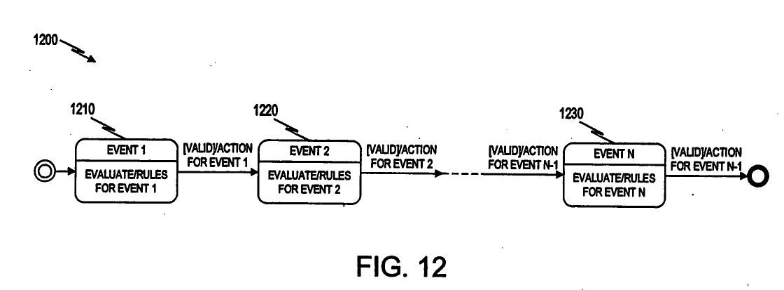

A software system that implements a workflow interpreter may be organized as a finite state machine. FIG. 12 shows a generalized finite state machine 1200 with exemplary states 1210, 1220 and 1230.

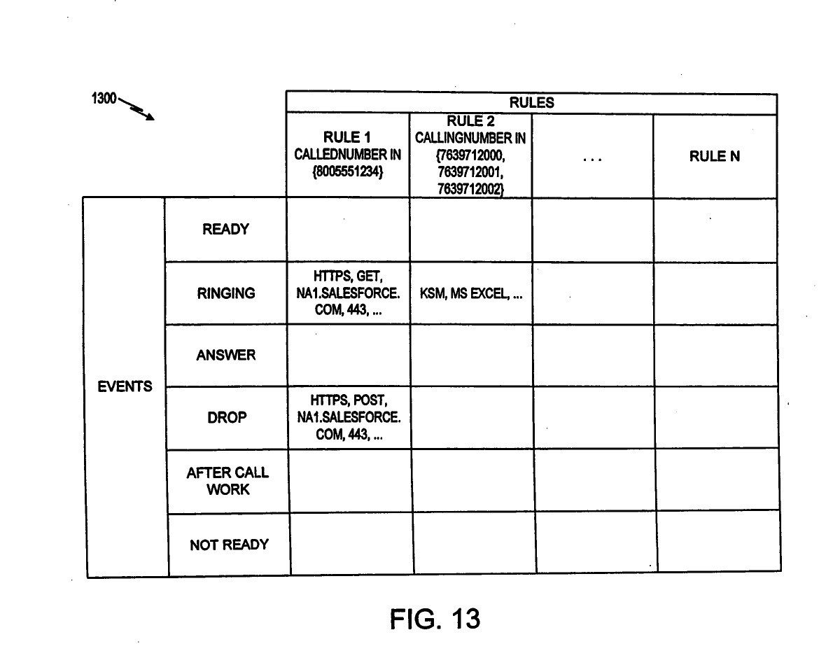

FIG. 13 provides a table 1300 that shows an abstracted view of the internal operation of the desktop with an illustrative set of events, rules and actions. A cell specifies the actions that should be executed when a rule is evaluated to be true for a given event. In the table 1300, some of the rules and actions are simplified and others are omitted for clarity and ease of understanding.

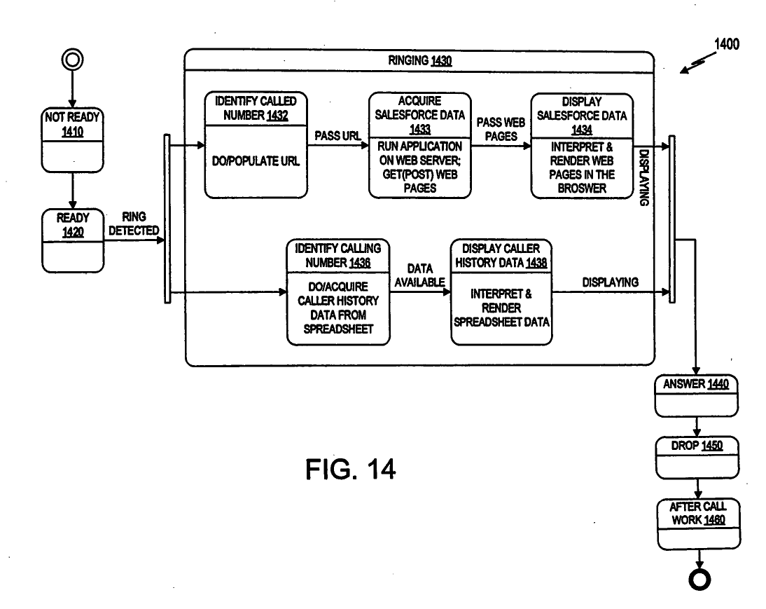

FIG. 14 is an example of a finite state machine 1400 that illustratively has states 1410, 1420, 1430, 1440, 1450 and 1460 respectively defined by the following events: not ready, ready, ringing, answer, drop, and after call work. Ringing state 1430 is shown as a composite state having a number of substates. When an agent desktop evaluates a workflow to be true and it has an action to execute that specifies integration with a web based application, the following is done. Upon entry into the Identify Called Number substate 1432, a method is invoked by which a URL is constructed by the desktop workflow interpreter. The URL fields that require CTI or IVR data are populated with the data that is associated with the call. The CTI and IVR data is either delivered to the agent desktop with the events or retrieved by the desktop sending a message. The CTI/IVR data either uniquely identifies the caller or what service the caller is requesting. The fully populated URL is passed to the browser integrated within the agent desktop. Upon entry into the Acquire Salesforce Data substate 1433, a method is invoked by which the URL transmitted to the web server is passed to the appropriate application. The results of the browser action (i.e., post or get) will result in the web server returning a page that has data specific to the caller. Upon entry into the Display Salesforce Data substate 1434 a method is invoked by which the returned web page is interpreted and rendered in the browser. Other substates such as an Identify Calling Number state 1436 and a Display Caller History Data substate 1438 may also be included in the Ringing state 1430, if desired. This results in the agent being able to view information specific to the caller without having entered any data.

The invention is set forth in the following claims. A variety of different permutations of the invention are possible, and the invention is not meant to be limited by this disclosure, or limited to the embodiments described herein. The embodiments are merely exemplary, and one skilled in the art will recognize that many others are possible, and that numerous modifications and adaptations can be resorted to without departing from the scope and fair meaning of the instant invention as set forth below by the claims.

Although the present invention has been described in considerable detail with reference to certain preferred versions thereof, other versions are possible. Therefore, the spirit and scope of the appended claims should not be limited to the description of the preferred versions described herein.

All features disclosed herein, and all the steps of any method or process disclosed herein, may be combined in various combinations, except combinations where at least some of such features and/or steps are mutually exclusive. Each of the features disclosed herein, can be replaced by alternative features serving the same, equivalent, or similar purposes, unless expressly stated otherwise. Thus, unless expressly stated otherwise, each feature disclosed is one example of a generic series of equivalent or similar features.

1. A computer telephony integration method comprising:
establishing an agent desktop;
embedding a web-based browser in the agent desktop;
integrating a web-based application with the browser;
establishing a workflow automation model comprising a plurality of events, a plurality of respective rules for the events, and a plurality of respective actions for the rules, wherein each of the rules is expressed as one or more relations on computer telephony integration (“CTI”) data, and wherein at least one of the actions is an HTTP action having a request data field;
upon occurrence of one of the events in the workflow automation model, evaluating a respective one of the rules;
upon valid evaluation of the evaluated rule, executing the HTTP action with the browser to obtain requested data in accordance with the request data field; and
providing the requested data to the web-based application.

2. The method of claim 1 wherein the HTTP action comprises a protocol definition, a method definition, a host application definition, a port definition, and a path definition.

3. The method of claim 1 wherein the HTTP action comprises a host application definition and a path definition.

4. The method of claim 1 wherein the HTTP action comprises a protocol definition, a method definition, a host application definition, and a path definition.

5. The method of claim 1 wherein:
the protocol definition is http or https; and
the method definition is GET or POST.

6. The method of claim 1 wherein the browser is embedded in a Windows application.

7. The method of claim 1 wherein the browser is a commercial browser.

8. The method of claim 1 further comprising interpreting the rule evaluating step, the HTTP action executing step, and the requested data providing step with a state machine model.

9. The method of claim 1 wherein the workflow automation model establishing step comprises installing the workflow automation model in a preconfigured condition.

10. The method of claim 1 wherein the workflow automation model establishing step comprises constructing the workflow automation model from user input.

11. The method of claim 1 further comprising populating the evaluated rule with CTI data prior to the rule evaluating step.

12. The method of claim 1 further comprising:
embedding a soft phone in the agent desktop; and
changing the agent's Automatic Call Distribution (“ACD”) state with the soft phone;
wherein the changing step corresponds to an occurrence of one of the events in the workflow automation model.

13. A contact center system comprising:
an internet connection;
a computer telephony integration (“CTI”) server; and
a client computer coupled to the internet connection and having associated therewith computer instructions for:
establishing an agent desktop on the client computer;
embedding a web-based browser in the agent desktop;
integrating a web-based application with the browser;
establishing a workflow automation model comprising a plurality of events, a plurality of respective rules for the events, and a plurality of respective actions for the rules, wherein each of the rules is expressed as one or more relations on computer telephony integration (“CTI”) data, and wherein at least one of the actions is an HTTP action having a request data field;
upon occurrence of one of the events in the workflow automation model, populating a respective one of the rules with CTI data from the CTI server, and evaluating the populated rule;
upon valid evaluation of the evaluated rule, executing the HTTP action with the browser to obtain requested data via the internet connection in accordance with the request data field; and
providing the requested data to the web-based application integrated in the browser.

14. The contact center system of claim 13, further comprising:
an enterprise application server;
wherein the client computer has associated therewith further computer instructions for acquiring the web-based application from the enterprise application server.

15. The contact center system of claim 13, wherein the client computer has associated therewith further computer instructions for acquiring the web-based application from a remote application server via the broadband internet connection.

16. A computer readable medium having computer program instructions stored thereon, comprising:
instructions for establishing an agent desktop;
instructions for embedding a web-based browser in the agent desktop;
instructions for integrating a web-based application with the browser;
instructions for establishing a workflow automation model comprising a plurality of events, a plurality of respective rules for the events, and a plurality of respective actions for the rules, wherein each of the rules is expressed as one or more relations on computer telephony integration (“CTI”) data, and wherein at least one of the actions is an HTTP action having a request data field;
instructions for, upon occurrence of one of the events in the workflow automation model, evaluating a respective one of the rules;
instructions for, upon valid evaluation of the evaluated rule, executing the HTTP action with the browser to obtain requested data in accordance with the request data field; and
instructions for providing the requested data to the web-based application.

17. The medium of claim 16 wherein the instructions for establishing the workflow automation model comprises instructions for installing the workflow automation model in a preconfigured condition.

18. The medium of claim 16 wherein the instructions for establishing the workflow automation model comprises instructions for constructing the workflow automation model from user input.

19. The medium of claim 16 further comprising:
instructions for embedding a soft phone in the agent desktop; and
instructions for changing the agent's Automatic Call Distribution (“ACD”) state with the soft phone, the change in the agent's ACD state corresponding to an occurrence of one of the events in the workflow automation model.

20. The medium of claim 16 wherein the rule evaluating instructions, the HTTP action executing instructions, and the requested data providing instructions implement a state machine model.
